(19) United States
(12) Patent Application Publication
(10) Pub. No.: US 2015/0186599 A1
(43) Pub. Date: Jul. 2, 2015

(54) INTEGRATED ORTHOPEDIC EXAMINATION AND IMAGE MANAGEMENT SYSTEM

(71) Applicants: Paul Lee McCune, Ovilla, TX (US); Paul Morgan McCune, Ovilla, TX (US)

(72) Inventors: Paul Lee McCune, Ovilla, TX (US); Paul Morgan McCune, Ovilla, TX (US)

(21) Appl. No.: 14/146,392

(22) Filed: Jan. 2, 2014

(51) Int. Cl. G06F 19/00

(52) U.S. Cl. CPC G06F 19/321

(57) ABSTRACT

Phoenix Ortho, LLC ahs created a wholly unique, Integrated Orthopedic examination, image acquisition storage, retrieval, and management and documentation solution. This solution creates workflow enhancements, patient record security, and image access, availability and provider efficiencies not previously available.

### CROSS-REFERENCES TO RELATED APPLICATIONS

This present patent application depends on provisional patent application 61/769,162, “Orthopedic Examination, Image Acquisition Storage, Retrieval, and Management and Documentation Solution,” filed by Paul L. McCune on Feb. 25, 2013.

### STATEMENT REGARDING FEDERALLY SPONSORED R&D

None.

### THE NAMES OF THE PARTIES TO A JOINT RESEARCH AGREEMENT

None.

### INCORPORATION-BY-REFERENCE OF MATERIAL SUBMITTED ON A COMPACT DISC

None.

### BACKGROUND OF THE INVENTION

1. Field of the Invention

The present disclosure relates generally to electronically stored medical records for orthopedic professionals.

2. Background Art

Any person having ordinary skill in the art will understand DICOM standards (from Digital Imaging and Communications in Medicine), which have been developed by the National Electrical Manufacturers Association. DICOM standards establish file protocol for transport, display and image storage with respect to electronic medical records.

DICOM enables the integration of scanners, servers, workstations, printers, and network hardware from multiple manufacturers into a picture archiving and communication system (PACS).

Medical records have frequently been targeted with unauthorized access. Congress has passed regulations to protect patient privacy rights.

Physicians still need a system that will protect patients' privacy while ease use of stored records.

### BRIEF SUMMARY OF THE INVENTION

Phoenix Ortho, LLC has for the first time created a wholly unique, integrated orthopedic examination, image acquisition storage, retrieval, management and documentation solution. This solution creates workflow enhancements, patient record security, and image access, availability and provider efficiencies not previously available.

This storage methodology secures records and makes them readily available to authorized providers of care. Now for the first time ever within any EMR, the physician can view the images ordered from the form from which they originated.

Other features of the present disclosure will be apparent to those of ordinary skill in the art upon reference to the following detailed description taken in conjunction is with the accompanying drawings. Though this invention was developed for use by orthopedic professionals, the invention itself and the claims made are not limited to that field.

### BRIEF DESCRIPTION OF THE SEVERAL VIEWS OF THE DRAWINGS

For a better understanding of the disclosure, and to show by way of example how the same may be carried into effect, reference is now made to the detailed description along with the accompanying figures in which corresponding numerals in the different figures refer to corresponding parts and in which the drawings show several embodiments:

FIG. 1 depicts a first embodiment of an operational workflow connectivity between the components of the invention.

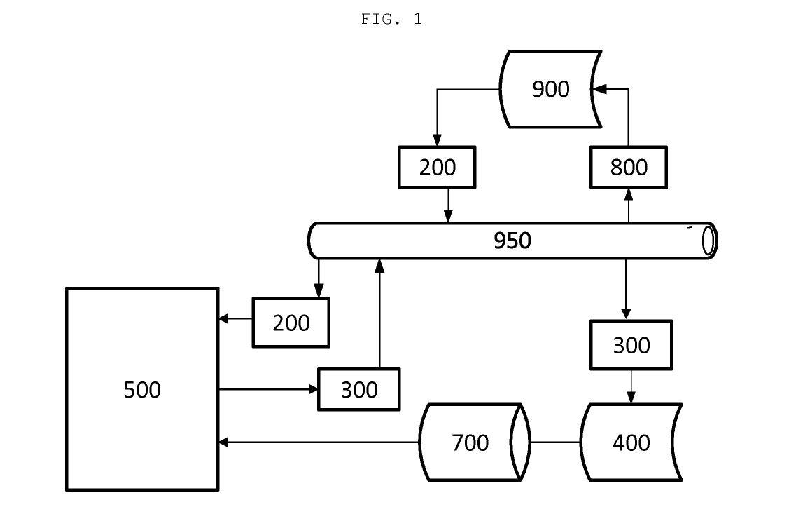

FIG. 2 depicts image management by the invention.

A listing of nomenclature used in the drawings and this specification includes the following:
Electronic Medical Record (EMR) 100
Order Entry (OE) 200
Imaging Order 300
Digital Image Acq. Device (DIAD) 400
Work List Server (WLS) 500
Unique Identifier (UID) 600
Phoenix Ortho Archive (POAC) 700
DICOM Image 800
Compressed Native DICOM 850
Work Station 900
Internet 950
Interface 150
Compressed JPEG Image 160
DICOM Image 170

### DETAILED DESCRIPTION OF THE INVENTION

The invented system employs DICOM standards for transmission of images and identification data.

In the invented system, a physician creates DICOM

Images 800 with the DIAD 400, also known as a “modality”, while treating patients. Usually these DICOM Images 800 are x-ray, MRI, or CT records.

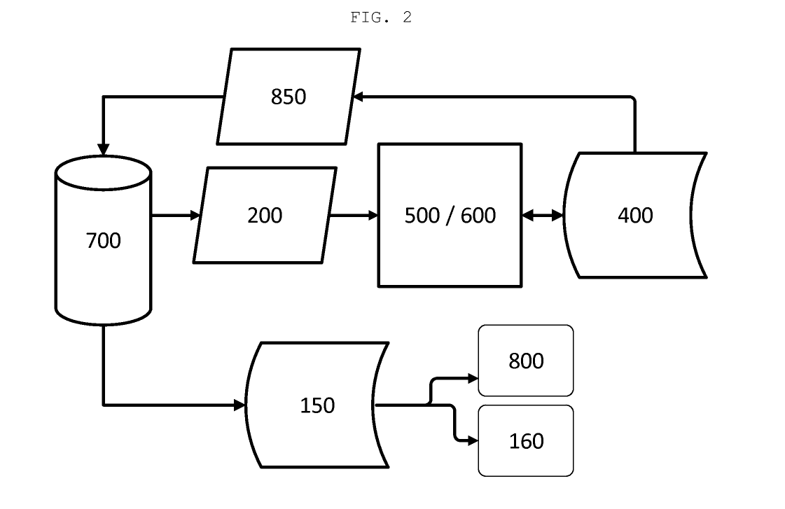

These records are stored in the Phoenix Ortho Archive (POAC) 700, an electronic archive, accessed by software WLS 500. As shown in FIG. 2, the DIAD 400 uses the UID 600 and WLS 500 input to create a DICOM Image 800 which retains patient and other information within the image. The DICOM Image 800 is transported, stored, and retrieved by a is single executable software application WLS 500, during which the UID 600 and other information is retained and possibly amended.

The system automatically compresses the image in a Lossless JPEG format and stores the image, tagging it with the WLS 500 and UID 600. The POAC 700 also stores the DICOM Image 800 in its native format.

The Invented System allows a physician to retrieve desired Electronic Medical Records (EMR) 100, which in this system comprises medical images with identifying information, producing the order at the point of care, by making an Order Entry (OE) 200 at a Work Station 900, and receiving the images on a computer display Interface 150.

The Invented System receives a physician's OE 200 and sends an Imaging Order 300 to any DICOM-compliant Digital Image Acquisition Device (DIAD) 400 through the software application, Work List Server (WLS) 500.

The DIAD 400 reads the OE 200 submitted in native DICOM format without translation.

Upon completion of image acquisition, the DIAD 400 submits the receives the requested images using the 45-character Unique Identifier (UID) 600 provided by the WLS 500 to the Phoenix Ortho Archive (POAC) 700.

The POAC 700 utilizes new File Stream technology available in the MS SQL 2008 DB to securely store both images.

The File Stream technology is unique, faster and more secure than previous alternatives by using a file structure internal to the database that includes the image tags (potentially the UID 600, IAD 400 and WLS 500) with the image, so there is no necessity of decomposing the image which subsequently requires decomposition to display the image.

The POAC 700 solution secures files from inadvertent access or destruction thus protecting patient privacy in a way not done before. With the images secured, the POAC 700 automatically retrieves and notifies the ordering provider that the OE 200 is complete.

Now for the first time ever within any emergency room, the physician can view the images ordered from the form from which they originated.

The Physician simply clicks on a thumbnail of the image on the Work Station 900 and immediately views the diagnostic quality digital images in either Compressed JPEG is 160 or DICOM format 800 via Interface 150 (typically a computer monitor, but potentially any image-displaying device).

The images are viewed by Phoenix Ortho's proprietary viewers to make this unique integrated solution a reality for the first time. From the same OE 200, a provider can view any thumbnail filmstrip of prior images with a single mouse click while viewing the output images on the Interface 150.

A user places the OE 200 at a Work Station 900, and the electronic request flows through the Ethernet and Internet 950 to the WLS 500, which issues the Imaging Order 300 to the DIAD 400 to generate an image using the UID 600 and WLS 500 identifying data. The DIAD 400 generates a Compressed Native DICOM image 850 which is stored in the POAC 700, where a user can recall the images through the Interface 150.

1. A system managing electronic medical records, comprising a programmed computer which uses DICOM standards to instructs image-producing modalities to use unique identifier information to create DICOM images, and store them electronically until requested by a user through the programmed computer.

2. The system as described in claim 1, in which a user accesses stored DICOM images at a console work station.

3. The system as described in claim 1, in which a single database manages EHRs.

4. The system as described in claim 1, in which the software application pre-fetches the images both shortly before and is after a time of interest, presenting them as a filmstrip to the user using a single application and single executable.
